(19) United States
(12) Patent Application Publication
(10) Pub. No.: US 2026/0204991 A1
(43) Pub. Date: Jul. 16, 2026

(54) Assembly process for a magnet module of a motor

(71) Applicant: Dongguan Jinconn New Material Co., Ltd., Dongguan (CN)

(72) Inventors: Liang CHEN, Dongguan (CN); Bin DU, Dongguan (CN); Zhaodi ZHAI, Dongguan (CN); Huaping XU, Dongguan (CN); Xiangyang LIU, Dongguan (CN); Yang LIU, Dongguan (CN)

(73) Assignee: Dongguan Jinconn New Material Co., Ltd., Dongguan (CN)

(21) Appl. No.: 19/425,958

(22) Filed: Dec. 18, 2025

(30) Foreign Application Priority Data
Jan. 10, 2025 (CN) 202510039197.8

(51) Int. Cl. H02K 15/035; H02K 1/278; H02K 15/12

(52) U.S. Cl. CPC H02K 15/035; H02K 1/278; H02K 15/12; H02K 2215/00

(57) ABSTRACT

The present invention relates to magnet technology and discloses an assembly process for a magnet module for electric motors. The process includes providing a motor component, mounting jig, fixing ring, base, demolding jig, installation tools, and a plurality of magnets with classification identifiers. The motor component is fixed on the base, and the fixing ring is fitted thereon. A mounting jig with receiving slots is installed, and magnetic isolation members are inserted to form magnet installation gaps. Adhesive is applied to the motor component and magnets, and first and second mutually attractive magnets are combined into attractive magnet groups and installed between adjacent magnetic isolation members. The magnetic isolation members are then withdrawn, and third magnets, which repel the attractive magnet groups, are installed between them to form a complete magnet module. This enables precise magnet positioning, prevents magnetic interference, simplifies assembly, and improves both efficiency and module quality.

### RELATED APPLICATIONS

The present patent document claims the benefit of priority to Patent Application No. 202510039197.8, filed January 10, 2025, and entitled “An assembly process for a magnet module of a motor,” the entire contents of each of which are incorporated herein by reference.

### BACKGROUND

### 1. Technical Field

The present invention relates to the field of magnet technology, and particularly discloses an assembly process for a magnet module of a motor.

### 2. Background Information

With the development of motor technology, outer rotor motors have been widely applied in the fields of industrial robots and high-performance servo motors due to their excellent heat dissipation performance and high torque density. The performance of an outer rotor motor directly depends on the installation accuracy and consistency of its magnet module. In traditional magnet module assembly processes, magnet gaps and polarity consistency are difficult to guarantee through conventional processes, thereby affecting the performance and reliability of the motor. The adhesive dispensing process is prone to overflow or uneven coating, leading to complications in subsequent operations. Additionally, traditional processes provide insufficient protection for non-working areas, which may cause contamination or component damage.

### BRIEF SUMMARY

In order to overcome the shortcomings and deficiencies of the prior art, the present invention aims to provide an improved assembly process for a magnet module. By introducing dedicated fixtures, magnetic-pole detection equipment, and precise dispensing and fixation techniques, the invention addresses the problems of the conventional processes and achieves an assembly workflow characterized by high efficiency, high precision, and a high degree of automation.

To achieve the above objective, the present invention provides an assembly process for a magnet module used in a motor, comprising the following steps:

Providing an installation jig, a fixing ring, a base, a demolding jig, an installation tool, protective members, a magnetic pole detection device, magnetic isolation members, cleaning tools, an oven, and an adhesive; and providing a plurality of magnets, which are classified, marked, and sequentially arranged；

S1: mounting a motor component onto a base, and fitting a fixing ring over an outer side of the motor component;

S2: mounting an installation jig on the motor component or on the base, wherein a plurality of receiving slots for accommodating individual magnets are formed on an outer side of the installation jig;

S3: inserting a plurality of magnetic isolation members respectively into the plurality of receiving slots of the installation jig, wherein an end of each magnetic isolation member protrudes from the installation jig and extends into a space between the fixing ring and the motor component;

S4: applying an adhesive onto the motor component and/or onto a plurality of magnets, and installing mutually attracting first magnets and second magnets between the fixing ring and the motor component, wherein the first magnets and the second magnets form a magnetic attraction set, and each magnetic attraction set is positioned between two adjacent magnetic isolation members;

S5: withdrawing the magnetic isolation members from the receiving slots, and inserting third magnets, via the receiving slots, into a position between the fixing ring and the motor component, wherein each third magnet is positioned between two adjacent magnetic attraction sets, the third magnets repel both the first magnets and the second magnets, and the first magnets, the second magnets, and the third magnets cooperatively form a desired magnet module on an outer side of the motor component (10).

Alternatively, the assembly process for a magnet module used in a motor further comprising the following step:

S6: using a magnetic pole detection device to detect polarity directions of all magnets in the magnet module mounted on the motor component, and removing the magnet having an incorrect polarity orientation and performing rework thereon.

Alternatively, the assembly process for a magnet module used in a motor further comprising the following step:

S7: placing the motor component, the magnet module, and the fixing ring, each having passed the magnetic pole detection, into an oven, and curing the adhesive by means of a high temperature inside the oven, and, after the adhesive has been cured, demolding the fixing ring from the rotor using a demolding jig so as to complete the assembly of the magnet module.

Alternatively, the plurality of magnets provided in step S1 are divided by markings into a plurality of first magnet bodies, a plurality of second magnet bodies, a plurality of third magnet bodies, a plurality of fourth magnet bodies, a plurality of fifth magnet bodies, and a plurality of sixth magnet bodies; the first magnets are any of the first magnet bodies, the third magnet bodies, the fourth magnet bodies, or the sixth magnet bodies; the second magnets are any of the sixth magnet bodies, the fourth magnet bodies, the third magnet bodies, or the first magnet bodies; and the third magnets are any of the second magnet bodies or the fifth magnet bodies; the first magnet bodies, the second magnet bodies, the third magnet bodies, the fourth magnet bodies, the fifth magnet bodies, and the sixth magnet bodies correspond one-to-one, and one first magnet body , one second magnet body, one third magnet body, one fourth magnet body, one fifth magnet body, and one sixth magnet body are combined to form a Halbach magnet array.

Alternatively, an adhesive is used to bond one first magnet body to one sixth magnet body to form a first magnet assembly, and to bond one third magnet body to one fourth magnet body to form a second magnet assembly; the first magnet assemblies and the second magnet assemblies are each provided in a plurality.

Alternatively, the said step S4 comprises:

(a) using an installation tool to install the plurality of first magnet assemblies respectively between two adjacent magnetic isolation members, and leaving two magnetic isolation members and two receiving slots vacant between adjacent first magnet assemblies;

(b) using the installation tool to install the plurality of second magnet assemblies respectively between the two magnetic isolation members located between adjacent first magnet assemblies, with the first magnet bodies positioned adjacent to the third magnet bodies;

(c) withdrawing the magnetic isolation members from the receiving slots, and installing the second magnet bodies between the first magnet bodies of the first magnet assemblies and the third magnet bodies of the second magnet assemblies;

(d) installing the fifth magnet bodies between the fourth magnet bodies of the second magnet assemblies and the sixth magnet bodies of the first magnet assemblies.

Alternatively, the installation jig is provided with a plurality of pressing blocks, with one pressing block formed between two adjacent receiving slots, the pressing blocks being configured to abut against and apply a pressing force to the ends of the magnets that face away from the base; and after the first magnets and the second magnets are installed in step S4, the installation jig is pressed downward such that the installation jig abuts against and presses the ends of the first magnets and the second magnets that face away from the base, until the opposite ends of all of the first magnets and all of the second magnets, namely the ends facing away from the installation jig, abut against the base and are flush therewith.

Alternatively, the assembly process for a magnet module used in a motor further comprising the following step:

Alternatively, after the third magnets are installed in step S5, the installation jig (1) is removed, and a compression jig is mounted on the motor component (10) or on the base (3); the compression jig is then pressed downward so as to abut against the ends of the third magnets that face away from the base (3), until the opposite ends of all of the third magnets, namely the ends facing away from the compression jig, abut against the base (3) and are flush therewith.

Alternatively, the step S7 comprises setting the oven temperature to 80–90°C and placing the motor component, the magnet module mounted on the motor component, and the fixing ring into the oven for baking for 2 hours; and prior to fitting the fixing ring onto the motor component, a demolding wax is applied to the surface of the fixing ring that faces the motor component so as to facilitate demolding of the fixing ring.

Alternatively, the demolding jig comprises a first demolding member and a second demolding member; the first demolding member comprises a first base body and a columnar protrusion provided thereon, the columnar protrusion being formed with a mounting hole at a central portion thereof for receiving a shaft body of the motor component; and the second demolding member comprises a second base body and an annular protrusion provided thereon, an inner diameter of the annular protrusion being greater than an outer diameter of the magnet module mounted on the motor component such that the annular protrusion is fitted over the magnet module and abuts against the fixing ring to enable demolding of the fixing ring.

Alternatively, after said step S6, appearance inspection and surface cleaning are performed, wherein a cleaning tool is used to clean residual adhesive on the surface of the magnet module, and a magnetic pole detection device is used to detect the magnetic poles of each magnet in the magnet module, and the motor component and magnet module that have passed inspection and been cleaned proceed to the next process step.

Alternatively, after said appearance inspection and surface cleaning step, testing equipment is used to test the mechanical performance and electrical performance of the motor component and magnet module to ensure that the assembly quality of the magnet module meets predetermined standards.

The assembly process for a motor magnet module provided by the present invention achieves precise positioning through the cooperative use of a dedicated installation jig and magnetic isolation members, and correct pairing of the magnets is ensured by classifying and marking the magnets in advance and assembling them in accordance with a predetermined sequence. During the assembly process, a magnetic pole detection device is employed to perform multiple polarity checks so as to guarantee consistency of magnet polarity. In addition, an innovative stepwise adhesive-dispensing process and a clearance-providing installation technique are adopted to achieve precise installation of the magnets. Meanwhile, a curing process combining the fixing ring and demolding wax is established to ensure the overall stability of the magnet module and facilitate subsequent demolding operations.

The beneficial effects of the present invention are as follows: Compared with traditional processes, the present invention resolves the problem of an uneven spacing between magnets by employing a precise positioning system formed by the dedicated installation jig and magnetic-isolation members, and multiple magnetic-pole detections, together with the predetermined assembly sequence, effectively ensure uniform polarity orientation among the magnets. The innovative step-by-step adhesive dispensing and clearance installation process avoids adhesive overflow and uneven coating phenomena, while the provision of protective members effectively prevents contamination and component damage during the assembly process. Furthermore, the combined use of the fixing ring and demolding wax simplifies the demolding operation and improves production efficiency, and the complete detection system ensures the assembly quality of the magnet module and the reliability of motor performance.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a process flow chart of the assembly process for a magnet module of a motor according to the present invention;

FIG. 2 is a schematic structural diagram of the combined structure of the installation jig, magnetic isolation members, motor component, fixing ring, and base according to the present invention;

FIG. 3 is a schematic structural diagram showing the magnetic isolation members being removed from the receiving slots via the installation tool in FIG. 2;

FIG. 4 is a schematic structural diagram of FIG. 2 in an exploded state;

FIG. 5 is an enlarged schematic structural diagram of portion A in FIG. 4;

FIG. 6 is a schematic structural diagram during demolding using the demolding jig according to the present invention;

FIG. 7 is a schematic structural diagram after the demolding jig demolds the fixing ring from the magnet module according to the present invention;

FIG. 8 is a schematic structural diagram after the magnet module is assembled to the motor component according to the present invention;

FIG. 9 is a partial magnetic pole arrangement schematic diagram after the magnet module assembly according to the present invention.

### Reference numerals include

1. Installation jig; 10. Motor component; 11. Shaft body; 2. Fixing ring; 3. Base; 4. Demolding jig; 41. First demolding member; 410. First base body; 411. Columnar protrusion; 412. Mounting hole; 42. Second demolding member; 420. Second base body; 421. Annular protrusion; 5. Installation tool; 6. Magnetic isolation member; 61. Easy-removal notch; 11. Receiving slot; 71. First magnet body; 72. Second magnet body; 73. Third magnet body; 74. Fourth magnet body; 75. Fifth magnet body; 76. Sixth magnet body; 100. First magnet assembly; 200. Second magnet assembly; 300. Magnet module.

### DETAILED DESCRIPTION OF THE DRAWINGS AND THE PRESENTLY PREFERRED EMBODIMENTS

The invention will be further described below in details with reference to the figures and embodiments.

In the following description, suffixes such as “module”, “component” or “unit” used to denote elements are defined only to facilitate the description of the present invention, and have no specific meaning in themselves. Therefore, “module”, “component” or “unit” is used alternatively.

It should be explained that the term “first” and “second” in the description, claims and the above drawings of the present invention are used to distinguish similar objects, instead of describing specific sequences or order.

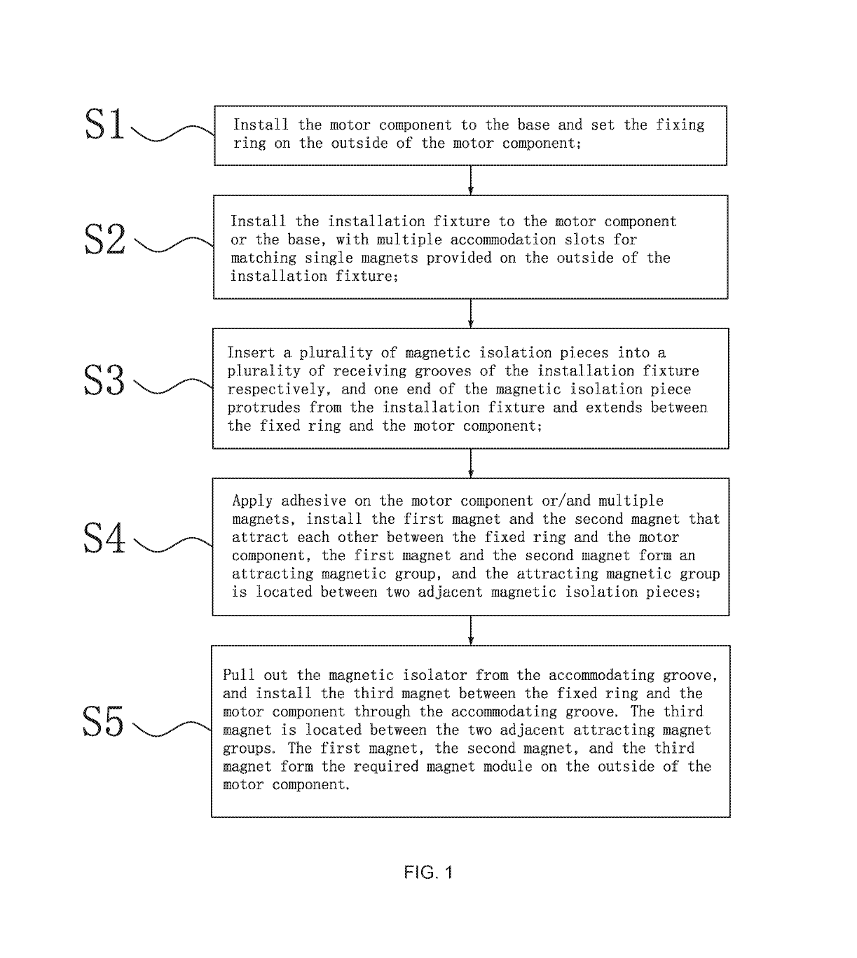

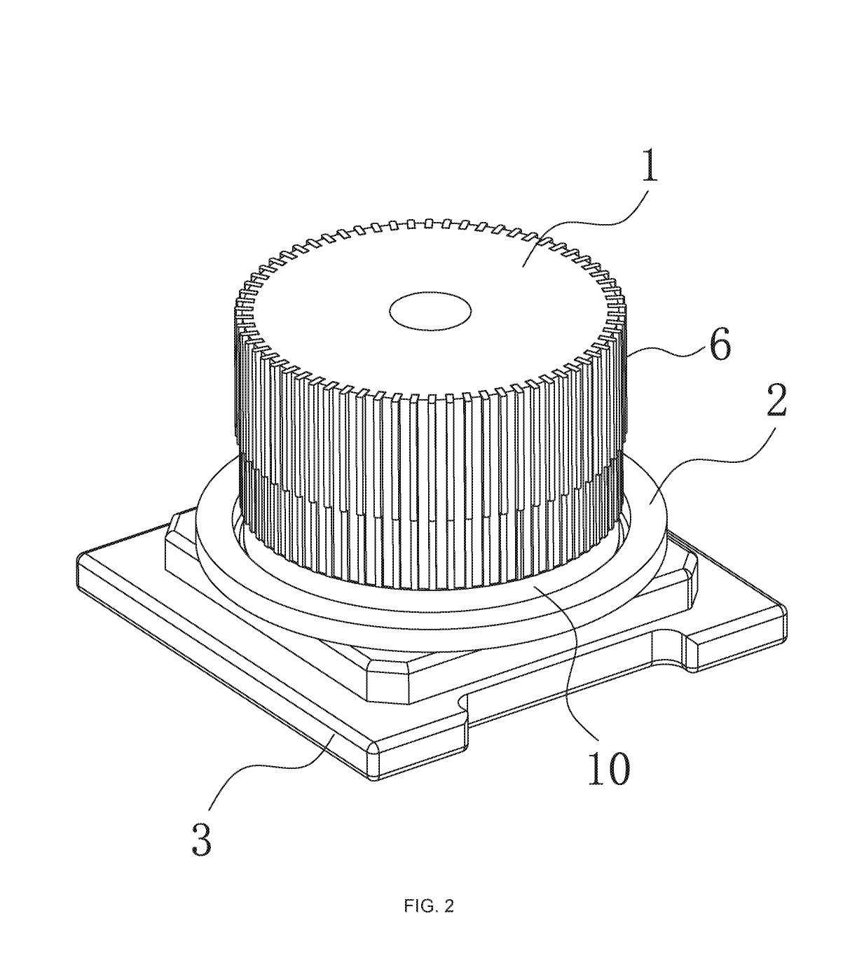

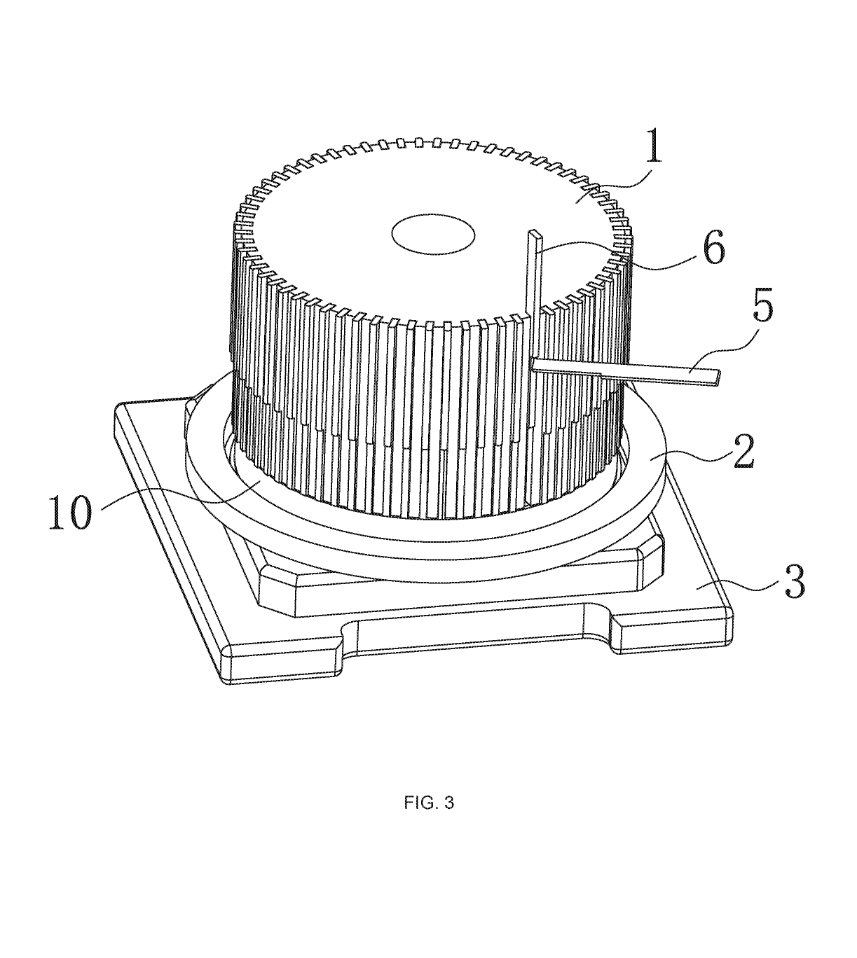

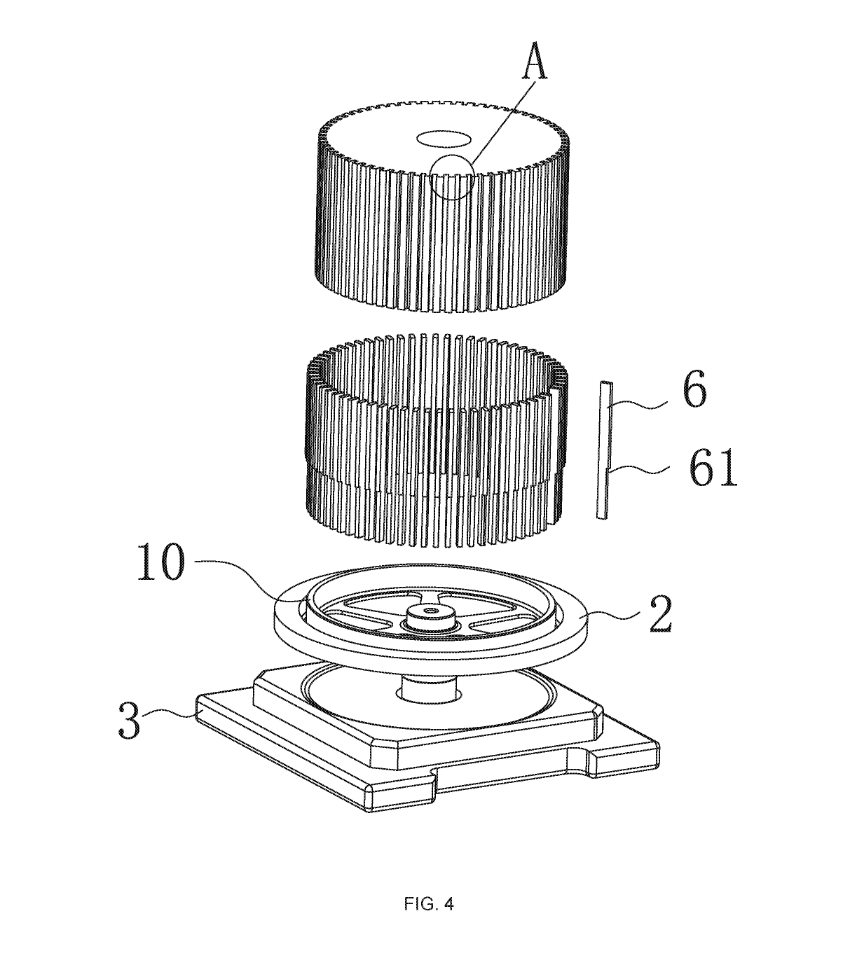

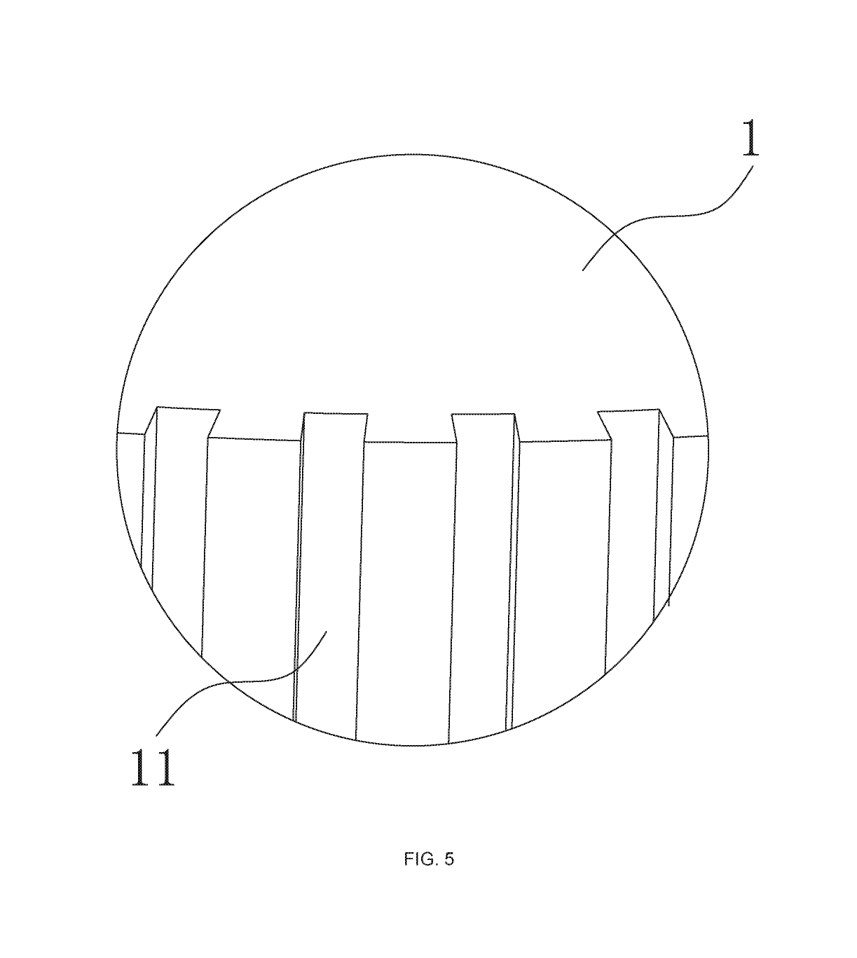

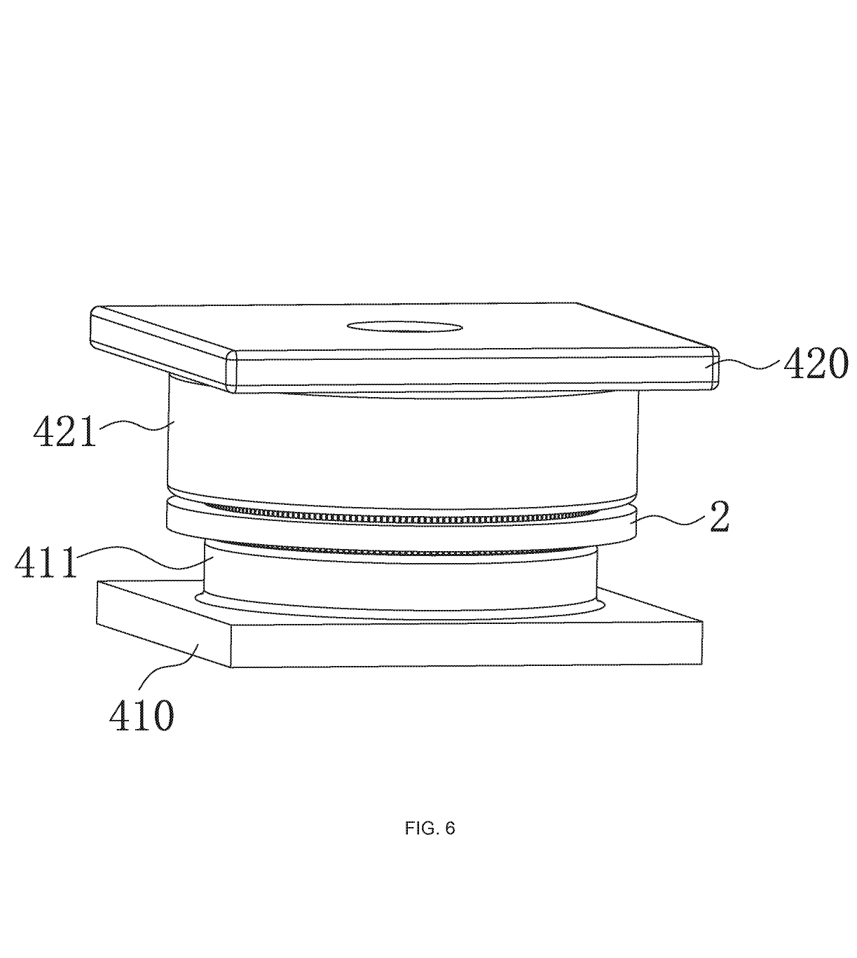

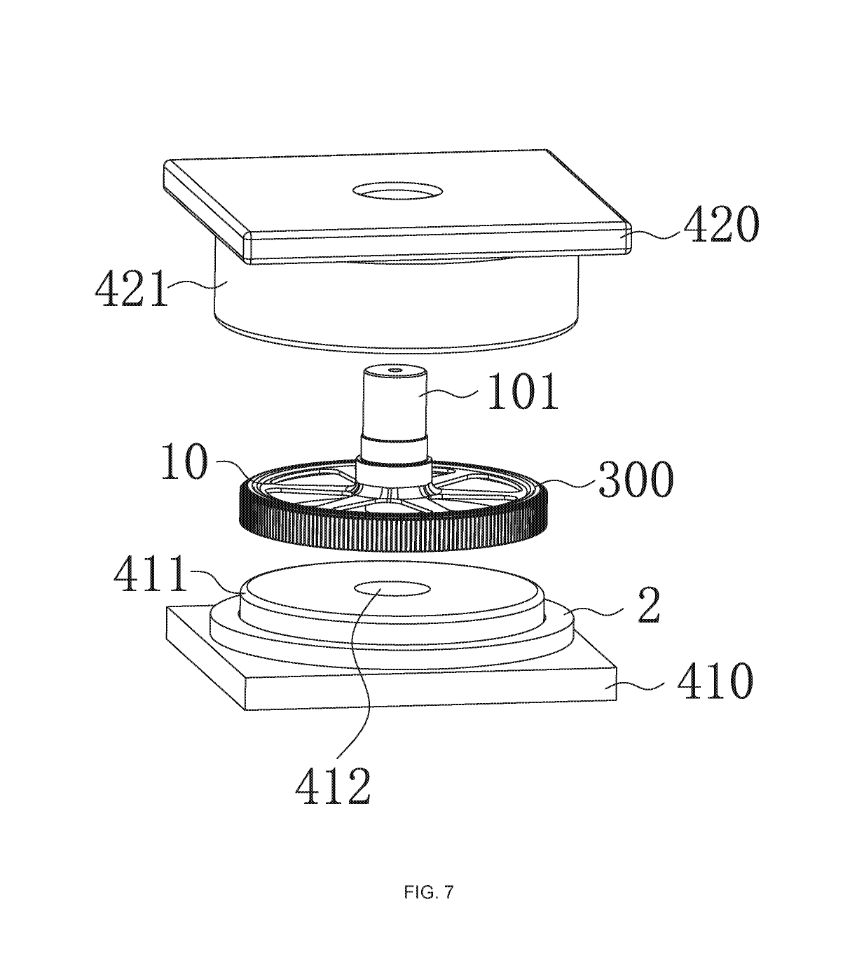

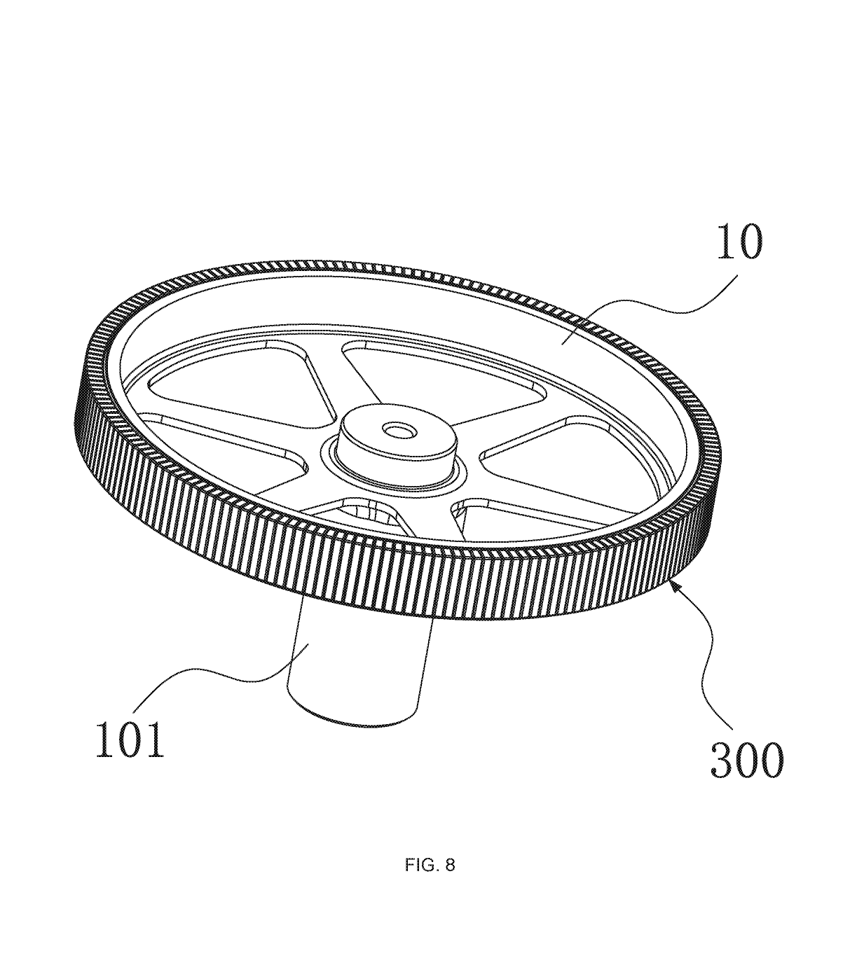

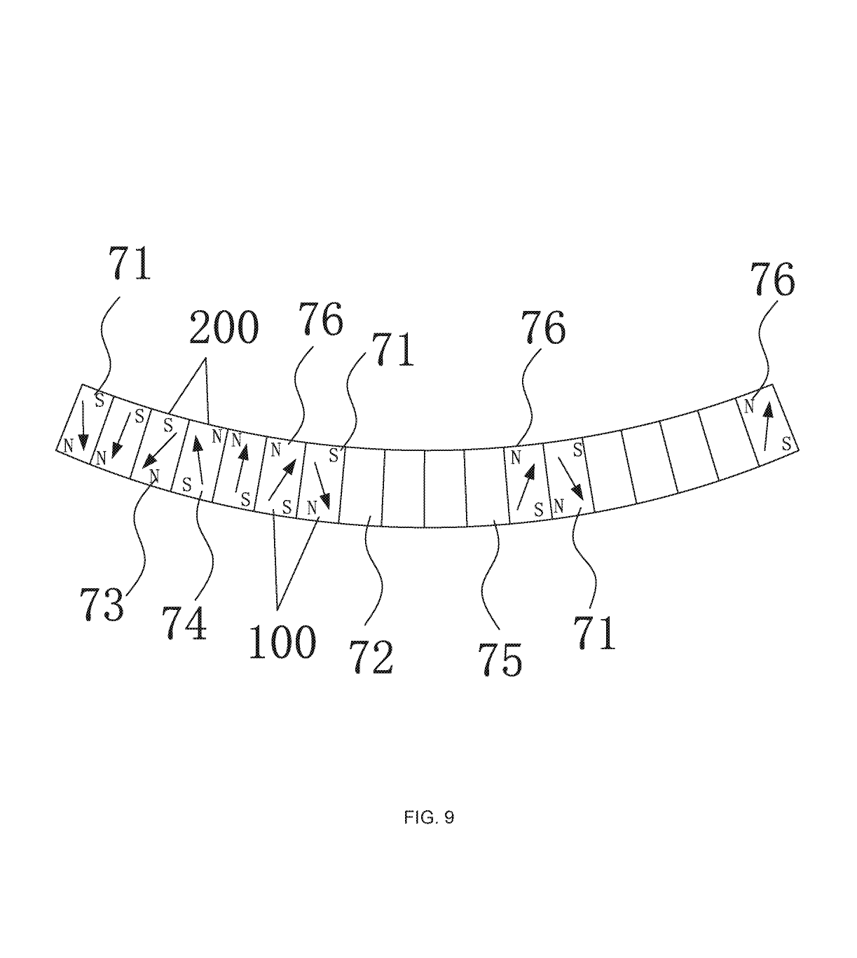

Referring to FIGS. 1 to 9, the present invention provides an assembly process for a magnet module of a motor, specifically comprising the following steps:

An assembly process for a magnet module of a motor, comprising the following steps:

### Work Preparation

Preparing an installation jig (1), a fixing ring (2), a base (3), a demolding jig (4), an installation tool (5), protective components, a magnetic-pole detection device, magnetic isolation members (6), cleaning tools, an oven, and an adhesive; and providing a plurality of magnets, which are classified, marked, and placed sequentially.

S1, Mounting a motor component (10) onto the base (3), and fitting the fixing ring (2) over an outer circumferential side of the motor component (10).

S2, Mounting the installation jig (1) onto the motor component (10) or onto the base (3). An outer side of the installation jig (1) is formed with a plurality of receiving slots (11) configured to accommodate individual magnets. The receiving slots 11 extend through the installation jig 1 in a direction along a central axis of the installation jig 1, and the plurality of receiving slots 11 are arranged in an annular array around the central axis of the installation jig 1.

Preferably, the receiving slots 11 extend through the side surface of the installation jig 1. In this embodiment, the main body shape of the installation jig 1 is cylindrical.

S3, Inserting a plurality of magnetic isolation members 6 respectively into the plurality of receiving slots 11 of the installation jig 1, such that one end of each magnetic isolation member (6) protrudes out of the installation jig (1) and extends into a space between the fixing ring (2) and the motor component (10). The magnetic isolation members (6) are generally straight, thin strips, preferably rectangular plates. Depending on actual requirements, the magnetic isolation members (6) may be made of an aluminum alloy or stainless steel. Compared with isolation members made of iron sheets, such materials prevent the isolation members (6) from being attracted by the magnetic force of the magnets during assembly, thereby avoiding operational inconvenience.

S4, Applying the adhesive on the motor component (10) and/or on the magnets. According to actual needs, the adhesive may be manually applied to the motor component 10 or the magnets with a brush or dispensing tool, or the adhesive can also be applied to the motor component 10 or the magnets automatically using an adhesive-dispensing device. Mutually attracting first magnets and second magnets are then mounted between the fixing ring (2) and the motor component (10). The first magnets and the second magnets form an attractive magnet set, and each attractive magnet set is positioned between two adjacent magnetic isolation members (6).

S5, Withdrawing the magnetic isolation members (6) from the receiving slots (11). Through the receiving slots (11), inserting third magnets into the space between the fixing ring (2) and the motor component (10), such that each third magnet is positioned between two adjacent attractive magnet sets. Each third magnet repels both the corresponding first magnet and second magnet. The first magnets, second magnets, and third magnets cooperate to form a desired magnet module (300) on an outer side of the motor component (10).

S6, Using the magnetic-pole detection device to detect the polarity direction of each magnet in the magnet module (300) mounted on the motor component (10). Any magnet whose polarity direction is incorrectly oriented is removed and reworked.

S7, Placing the motor component (10), the magnet module (300), and the fixing ring (2), which have passed polarity inspection, into the oven and curing the adhesive at high temperature inside the oven. After the adhesive is cured, demolding the fixing ring (2) from the motor component (10) using the demolding jig (4), thereby completing the assembly of the magnet module (300).

The main steps of the process include work preparation, installation of the magnetic isolation members (6), magnet grouping and inspection, magnet installation, polarity detection and cleaning, curing and demolding, and final performance testing. Through precise jig design, positioning assistance provided by the magnetic isolation members (6), and a stepwise adhesive-dispensing and assembly process, uniform magnet spacing, consistent magnet polarity, and uniform adhesive application are ensured. In addition, the use of a magnetic-pole detection device, cleaning tools, and dedicated testing equipment ensures that the mechanical and electrical performance of the magnet module (300) meets the required design standards.

Specifically, the motor component (10) provided during the work-preparation stage is a rotor. The installation jig (1) is a cylindrical jig provided with a central opening and a plurality of receiving slots (11) formed around the central opening. The mounting base (3) is placed on a supporting surface of an external structure and serves to support the motor component (10) and the installation jig (1) during assembly of the magnet module (300). The inner diameter of the fixing ring (2) is greater than the outer diameter of the motor component (10) and allows a degree of elastic deformation, thereby permitting magnets to be inserted into the gap formed between the fixing ring (2) and the outer side of the motor component (10).

The demolding jig (4) comprises a first demolding member (41) and a second demolding member (42). The first demolding member (41) includes a rectangular parallelepiped-shaped first base body (410) and a columnar protrusion (411) disposed thereon. The columnar protrusion (411) is provided at its central portion with a mounting hole (412) for receiving the shaft body (11) of the motor component (10). The outer diameter of the columnar protrusion (411) is less than or equal to the inner diameter of the motor component (10), allowing the motor component (10) to be fitted over the columnar protrusion (411).

The second demolding member (42) includes a rectangular parallelepiped-shaped second base body (420) and an annular protrusion (421) disposed thereon. The inner diameter of the annular protrusion (421) is greater than the outer diameter of the magnet module (300) mounted on the outer side of the motor component (10), allowing the annular protrusion (421) to be fitted over the magnet module (300) and abut against the fixing ring (2) to facilitate demolding of the fixing ring (2).

The installation tool (5) is a magnetic-conductive member, which may be a screwdriver, the end of which is configured to pick up and hold magnets, replacing manual installation. The protective members comprise masking tape applied to the motor component (10). The magnetic pole detection device comprises a magnetic display card and a magnetic-pole detection rod. The magnetic isolation members (6) are pins configured to match the shape of the receiving slots (11), wherein the width of each pin exceeds the depth of the corresponding receiving slot. The cleaning tools include alcohol and non-woven fabric. The adhesive comprises glue of model EW6306LT-11 and a dispensing kit with a dispensing syringe.

Specifically, after completion of the work preparation, a pin operation is performed, i.e., installation of the magnetic isolation members (6). First, the non-working portions of the motor component (10), namely the central frame, are wrapped with masking tape (protective member). The motor component (10) is then placed on the base (3), and a layer of demolding wax is applied to the inner circular surface of the fixing ring (2), which is then fitted over the outer side of the motor component (10), leaving an installation gap between the fixing ring (2) and the motor component (10), since the inner diameter of the fixing ring (2) is greater than the outer diameter of the motor component (10). The base (3) is provided with a limiting structure for positioning the fixing ring (2), which may include an annular protruding rib, with a corresponding annular groove formed in the bottom wall of the fixing ring (2) for receiving the rib. This design further ensures the stability of the fixing ring (2), preventing any displacement of the magnets during installation of the magnet module.

Thereafter, the installation jig (1) is mounted on the motor component (10), with the central opening aligned with the shaft body (11) of the motor component (10) for proper positioning. A plurality of magnetic isolation members (6) are subsequently installed in the receiving slots (11) of the installation jig (1). Once installed, the magnetic isolation members (6) are secured in the installation jig (1) using cable ties. Finally, the installation jig (1) is raised, and three iron columns are inserted into the gap between the installation jig (1) and the motor component (10) to elevate the installation jig (1).

Specifically, after the magnetic isolation members (6) are installed, the magnets are classified and combined. The first magnet body (71) and the sixth magnet body (76) are combined to form a first magnet assembly (100). After bonding with adhesive applied using a dispensing syringe, the first magnet assemblies (100) are marked with an oil-based pen using a red double line. The number of first magnet assemblies 100 is 33 sets. Thereafter, the third magnet body (73) and the fourth magnet body (74) are combined to form a second magnet assembly (200). After bonding with adhesive applied using a dispensing syringe, the second magnet assemblies (200) are marked with an oil-based pen using a black double line. The number of second magnet assemblies (200) is equal to the number of first magnet assemblies (100).

Specifically, after the first magnet assemblies 100 and the second magnet assemblies 200 are combined and installed, adhesive is applied at the magnet mounting positions on the outer side of the motor component (10) using a dispensing syringe. Using the installation tool (5), 33 sets of first magnet assemblies (100) are sequentially installed in the installation gaps between two adjacent magnetic isolation members (6) and are clamped between the inner circular surface of the fixing ring (2) and the outer circular surface of the motor component (10). Two magnetic isolation members (6), i.e., one installation gap, are left vacant between two adjacent first magnet assemblies (100) to accommodate subsequent installation of the second magnet assemblies (200).

Specifically, after the first magnet assemblies (100) and the second magnet assemblies (200) are installed, the installation jig (1) is rotated, and the pressing blocks formed between two adjacent receiving slots (11) on the installation jig (1) are used to abut against the ends of the first magnet assemblies (100) and the second magnet assemblies (200) that are away from the base (3), until the ends of all the first magnet assemblies 100 and the second magnet assemblies 200 that are away from the installation jig 1 are flush with the base (3). The motor component (10) and the installation jig (1) are then inverted, and the polarity of each magnet installed on the outer side of the motor component (10) is verified using a magnetic display card. If there is an error in the magnetic display, any magnet with incorrect polarity is replaced with a magnet having the correct polarity.

Specifically, after confirming that all magnets of the first and second magnet assemblies (100, 200) are correct, portions of the pins are lifted upward out of the receiving slots (11) to create installation positions for the second magnet bodies (72). Adhesive is dispensed at these positions, specifically in the receiving slots (11) located between the first magnet bodies (71) and the third magnet bodies (73). During installation of the second magnet bodies (72), for each time a pin removed, adhesive is first applied to the vacated receiving slot (11), then the second magnet body (72) is inserted into the receiving slot 11 using the installation tool (5). The pin is then pushed downward to press the second magnet body (72) into the adhesive, securing it tightly. After installing each second magnet body (72), one pin is skipped before removing the next pin. This process is repeated until all 33 pieces of second magnet bodies (72) are installed.

Specifically, after the second magnet bodies (72) are installed, thirty-three pieces of the fifth magnet bodies (75) are installed in the same manner as the second magnet bodies (72). The installed magnet module (300) and the pins are secured with cable ties. After all the second and fifth magnet bodies (72, 75) are installed, the compression jig provided during the work preparation is mounted on the base (3) and pressed down to apply pressure to the ends of the second and fifth magnet bodies (72, 75) that are away from the base (3), until the ends of all the second magnet bodies 72 and fifth magnet bodies 75 that are away from the compression jig are flush with the base (3).

Specifically, after assembly of the magnet module (300), the installation jig (1) is removed, and residual adhesive on the magnet module (300), pins, motor component (10), and other installation tools (5) is wiped clean using non-woven fabric and alcohol. The fixing ring (2) is then reinstalled on the outer side of the magnet module (300).

Specifically, after removing the installation jig 1 and adding the fixing ring 2, the polarity of all magnets in the magnet module (300) on the motor component (10) is verified again using a magnetic display card. Any magnet displaying incorrect polarity is replaced with a magnet of correct polarity. Once all magnets in the magnet module (300) have correct polarity, residual adhesive on the magnet surfaces is wiped clean using non-woven fabric dipped in alcohol. The position of the fixing ring (2) is then adjusted to expose the opposite ends of the magnets, and any remaining adhesive on these surfaces is cleaned.

Specifically, after cleaning the surface of the magnet module (300), the curing step is performed. In the curing step, to ensure firm adhesive bonding of the magnet module (300) and facilitate subsequent demolding, the following operation steps and device parameters are employed. An industrial constant-temperature oven is used, with a temperature control range from room temperature to 200°C. Once the actual oven temperature reaches 85°C, the motor component (10), the fixing ring (2), and the magnet module (300) are placed inside and heated to 90°C. A digital constant-temperature controller is used to maintain a stable temperature of 90°C. The curing duration is set to 2 hours to ensure complete curing of the adhesive, thereby achieving the designed strength and durability. To prevent heat damage to the components, the motor component (10) and the fixing ring (2) are fully prepared prior to being placed in the oven.

During the aforementioned installation of the fixing ring (2), a layer of demolding wax is uniformly applied to the side facing the magnet module (300). The demolding wax is an industrial high-efficiency demolding agent, applied to a thickness of 0.05–0.1 mm. During the coating process, a dedicated coating tool, such as a silicone brush or coating roller, is used to evenly cover the entire contact surface, avoiding areas that are too thick or too thin. After coating, the assembly is left to stand for 5 minutes to allow the demolding wax to form a stable release layer. Thereafter, the fixing ring (2) and the magnet module (300) are combined and assembled.

Specifically, after baking is completed, the motor component (10) assembly is removed and cooled to room temperature by natural air cooling to prevent thermal expansion and contraction stresses caused by rapid cooling that could damage the magnet module (300). After cooling, the motor component (10) assembly is mounted on the first demolding member (41) of the demolding jig (4), and the annular protrusion (421) of the second demolding member (42) is used to abut against and push the fixing ring (2) smoothly away from the motor component (10) in the axial direction. During this operation, the fixing ring (2) is gently rotated while pushing the second demolding member (42) to avoid any sudden impact or tearing, thereby preventing damage to the bonding surface or the magnet module (300).

Specifically, after demolding, an appearance inspection is conducted on the magnet module (300) and the motor component (10). High-precision optical detection equipment, such as an industrial camera or microscope, is used to examine the surface of the magnet module (300) for adhesive overflow, cracks, scratches, and the integrity of the magnet surface coating. Areas with adhesive overflow are cleaned using flexible cleaning tools, such as lint-free cloths and alcohol solution, to remove residual adhesive without damaging the magnet surface coating. The motor component (10) is also inspected to ensure there are no collision marks or structural defects. Non-working areas are cleaned as well to ensure complete and proper assembly.

The above operations ensure high precision and consistency of the magnet module (300) during assembly. Through appropriate jig design, positioning of the magnetic isolation members (6), and a stepwise adhesive dispensing process, the magnet spacing, adhesive coating uniformity, and magnet polarity consistency are effectively controlled. Repeated polarity inspections and cleaning steps minimize quality issues. Proper use of demolding wax and cable ties ensures both the stability and ease of disassembly of the magnet module (300), prevents component damage, improves production efficiency, and increases the yield of finished products, thereby providing reliable technical support for the practical application of high-performance motors.

After cleaning, dedicated mechanical performance testing equipment is used to evaluate the motor component (10) and the magnet module (300). Mechanical performance testing includes the following:

Dynamic Balance Testing: The motor component (10) is placed on a dynamic balance tester with a detection accuracy of 1 mg. The balance of the motor component 10 is tested at a standard speed of 2000–3000 rpm to ensure that the eccentricity does not exceed the design limit (e.g., ≤0.1 g·cm).

Adhesive Strength Testing: A tensile testing machine applies a constant tensile force of 10–30 N to the bonding surface between the magnets and the motor component (10) to measure peel strength, ensuring that the adhesive strength meets the design requirement (e.g., ≥15 N/cm²).

Vibration Endurance Testing: To simulate operational vibration conditions, vibration testing equipment (amplitude 0.1–0.5 mm, frequency 50 Hz) is used to assess the durability of the assembled components.

Subsequently, electrical performance testing is carried out, comprising the following steps:

Magnetic Flux Measurement: The motor component (10) together with the magnet module (300) mounted thereon is placed in a magnetic flux tester to measure the magnetic flux density of the magnets at a standard working distance, ensuring that the magnetic field strength falls within the design range (e.g., 1.2–1.5 T).

Insulation Test: Using a high-voltage insulation resistance tester, a rated voltage (e.g., 1000 V) is applied between the magnet module (300) and the conductive parts of the motor component (10) to verify that the insulation resistance meets the required standard (e.g., ≥10 MΩ).

Withstand Voltage Test: A transient high voltage (e.g., 1500 V) is applied to the magnet module (300) to evaluate its withstand voltage capability, ensuring that no dielectric breakdown or abnormal behavior occurs.

Upon completion of the tests, all data are recorded and compared with the design specifications to confirm that both the electrical and mechanical performance of the magnet module (300) and motor component (10) meet the predetermined requirements. Components that pass the tests proceed to the subsequent processing steps, whereas those that fail are reworked or repaired in accordance with the test results.

It should be noted that, herein, the terms "include", "comprising" or any other variation thereof are intended to encompass non-exclusive inclusion, such that a process, method, article or device comprising a series of elements not only includes those elements, but also other elements not expressly listed or inherent to such a process, method, article or apparatus. Without further limitation, an element qualified by the phrase “comprising a....” does not preclude the presence of additional identical elements in a process, method, article or apparatus that includes the element.

The above-mentioned serial numbers of the embodiments of the present invention are only for description, and do not represent the embodiments are in any order.

The above embodiments, which are intended to enable those skilled in the art to understand the content of the disclosure and implement it accordingly, are merely for describing the technical concepts and features of the disclosure, and the scope of patent application of the disclosure cannot be defined only by the embodiments, i.e., any equivalent variations or modifications made in accordance with the spirit disclosed by the disclosure still fall within the scope of claims of the disclosure.

1. An assembly process for a magnet module of a motor, comprising the following steps:
S1: mounting a motor component (10) onto a base (3), and fitting a fixing ring (2) over an outer side of the motor component (10);
S2: mounting an installation jig (1) on the motor component (10) or on the base (3), wherein a plurality of receiving slots (11) for accommodating individual magnets are formed on an outer side of the installation jig (1);
S3: inserting a plurality of magnetic isolation members (6) respectively into the plurality of receiving slots (11) of the installation jig (1), wherein an end of each magnetic isolation member (6) protrudes from the installation jig (1) and extends into a space between the fixing ring (2) and the motor component (10);
S4: applying an adhesive onto the motor component (10) and/or onto a plurality of magnets, and installing mutually attracting first magnets and second magnets between the fixing ring (2) and the motor component (10), wherein the first magnets and the second magnets form a magnetic attraction set, and each magnetic attraction set is positioned between two adjacent magnetic isolation members (6);
S5: withdrawing the magnetic isolation members (6) from the receiving slots (11), and inserting third magnets, via the receiving slots (11), into a position between the fixing ring (2) and the motor component (10), wherein each third magnet is positioned between two adjacent magnetic attraction sets, the third magnets repel both the first magnets and the second magnets, and the first magnets, the second magnets, and the third magnets cooperatively form a desired magnet module (300) on an outer side of the motor component (10).

2. The assembly process for a magnet module of a motor according to claim 1, further comprising the following step:
S6: using a magnetic pole detection device to detect polarity directions of all magnets in the magnet module (300) mounted on the motor component (10), and removing the magnet having an incorrect polarity orientation and performing rework thereon.

3. The assembly process for a magnet module of a motor according to claim 2, further comprising the following step:
S7: placing the motor component (10), the magnet module (300), and the fixing ring (2), each having passed the magnetic pole detection, into an oven, and curing the adhesive by means of a high temperature inside the oven, and, after the adhesive has been cured, demolding the fixing ring (2) from the rotor (10) using a demolding jig (4) so as to complete the assembly of the magnet module (300).

4. The assembly process for a magnet module of a motor according to claim 1, wherein the plurality of magnets provided in step S1 are divided by markings into a plurality of first magnet bodies (71), a plurality of second magnet bodies (72), a plurality of third magnet bodies (73), a plurality of fourth magnet bodies (74), a plurality of fifth magnet bodies (75), and a plurality of sixth magnet bodies (76);
wherein the first magnets are any of the first magnet bodies (71), the third magnet bodies (73), the fourth magnet bodies (74), or the sixth magnet bodies (76); the second magnets are any of the sixth magnet bodies (76), the fourth magnet bodies (74), the third magnet bodies (73), or the first magnet bodies (71); and the third magnets are any of the second magnet bodies (72) or the fifth magnet bodies (75);
the first magnet bodies (71), the second magnet bodies (72), the third magnet bodies (73), the fourth magnet bodies (74), the fifth magnet bodies (75), and the sixth magnet bodies (76) correspond one-to-one, and one first magnet body (71), one second magnet body (72), one third magnet body (73), one fourth magnet body (74), one fifth magnet body (75), and one sixth magnet body (76) are combined to form a Halbach magnet array.

5. The assembly process for a magnet module of a motor according to claim 4, wherein an adhesive is used to bond one first magnet body (71) to one sixth magnet body (76) to form a first magnet assembly (100),
and to bond one third magnet body (73) to one fourth magnet body (74) to form a second magnet assembly (200); wherein the first magnet assemblies (100) and the second magnet assemblies (200) are each provided in a plurality.

6. The assembly process for a magnet module of a motor according to claim 5, wherein said step S4 comprises:
(a) using an installation tool (5) to install the plurality of first magnet assemblies (100) respectively between two adjacent magnetic isolation members (6), and leaving two magnetic isolation members (6) and two receiving slots (11) vacant between adjacent first magnet assemblies (100);
(b) using the installation tool (5) to install the plurality of second magnet assemblies (200) respectively between the two magnetic isolation members (6) located between adjacent first magnet assemblies (100), with the first magnet bodies (71) positioned adjacent to the third magnet bodies (73);
(c) withdrawing the magnetic isolation members (6) from the receiving slots (11), and installing the second magnet bodies (72) between the first magnet bodies (71) of the first magnet assemblies (100) and the third magnet bodies (73) of the second magnet assemblies (200);
(d) installing the fifth magnet bodies (75) between the fourth magnet bodies (74) of the second magnet assemblies (200) and the sixth magnet bodies (76) of the first magnet assemblies (100).

7. The assembly process for a magnet module of a motor according to claim 1, wherein the installation jig (1) is provided with a plurality of pressing blocks, with one pressing block formed between two adjacent receiving slots (11), the pressing blocks being configured to abut against and apply a pressing force to the ends of the magnets that face away from the base (3);
and after the first magnets and the second magnets are installed in step S4, the installation jig (1) is pressed downward such that the installation jig (1) abuts against and presses the ends of the first magnets and the second magnets that face away from the base (3), until the opposite ends of all of the first magnets and all of the second magnets, namely the ends facing away from the installation jig (1), abut against the base (3) and are flush therewith.

8. The assembly process for a magnet module of a motor according to claim 1,
wherein, after the third magnets are installed in step S5, the installation jig (1) is removed, and a compression jig is mounted on the motor component (10) or on the base (3);
the compression jig is then pressed downward so as to abut against the ends of the third magnets that face away from the base (3), until the opposite ends of all of the third magnets, namely the ends facing away from the compression jig, abut against the base (3) and are flush therewith.

9. The assembly process for a magnet module of a motor according to claim 3,
wherein step S7 comprises setting the oven temperature to 80–90°C and placing the motor component (10), the magnet module (300) mounted on the motor component (10), and the fixing ring (2) into the oven for baking for 2 hours;
and wherein, prior to fitting the fixing ring (2) onto the motor component (10), a demolding wax is applied to the surface of the fixing ring (2) that faces the motor component (10) so as to facilitate demolding of the fixing ring (2).

10. The assembly process for a magnet module of a motor according to claim 3,
wherein the demolding jig (4) comprises a first demolding member (41) and a second demolding member (42);
the first demolding member (41) comprises a first base body (410) and a columnar protrusion (411) provided thereon, the columnar protrusion (411) being formed with a mounting hole (412) at a central portion thereof for receiving a shaft body (11) of the motor component (10);
and the second demolding member (42) comprises a second base body (420) and an annular protrusion (421) provided thereon, an inner diameter of the annular protrusion (421) being greater than an outer diameter of the magnet module (300) mounted on the motor component (10) such that the annular protrusion (421) is fitted over the magnet module (300) and abuts against the fixing ring (2) to enable demolding of the fixing ring (2).

11. The assembly process for a magnet module of a motor according to claim 4,
after said step S6, further comprises performing appearance inspection and surface cleaning, wherein residual adhesive on the surface of the magnet module is removed using cleaning tools, and the polarity of each magnet in the magnet module (300) is detected using a magnetic pole detection device, and motor component (10) and magnet module (300) that pass inspection and cleaning proceed to the next process step.

12. The assembly process for a magnet module of a motor according to claim 11, further comprises testing the mechanical and electrical performance of the motor component (10) and magnet module (300) using testing equipment to ensure that the assembly quality of the magnet module (10) meets predetermined standards.
